(19) United States
(12) Patent Application Publication
(10) Pub. No.: US 2023/0293382 A1
(43) Pub. Date: Sep. 21, 2023

(54) Walker Strap Device

(71) Applicant: Frances Stovall, Scottsville, KY (US)

(72) Inventor: Frances Stovall, Scottsville, KY (US)

(21) Appl. No.: 18/174,804

(22) Filed: Feb. 27, 2023

Related U.S. Application Data
(60) Provisional application No. 63/320,356, filed on Mar. 16, 2022.

(51) Int. Cl. A61H 3/00

(52) U.S. Cl. CPC A61H 3/008; A61H 2201/1626

(57) ABSTRACT

The present invention relates to a novel walker safety strap device. The device is a multipurpose strap that will assist a user in using a walker. The strap device functions as a bungee cord that will stretch from one side of the walker to the other, thereby providing the user with instruction for proper stance, balance, and distance from the walker. The walker safety strap device comprises a body component with a C-shaped hook at opposing ends which secure to the walker and a breakaway buckle in the middle. Generally, the strap device is elastic and adjustable based on the size of the user and/or walker to ensure that the strap device keeps the user inside the one-foot circle created by the walker during use.

### CROSS-REFERENCE TO RELATED APPLICATION

The present application claims priority to, and the benefit of, U.S. Provisional Application No. 63/320,356, which was filed on Mar. 16, 2022, and is incorporated herein by reference in its entirety.

### FIELD OF THE INVENTION

The present invention relates generally to the field of walker safety strap devices. More specifically, the present invention relates to a strap designed to assist people in maintaining stability when using a walker. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in walker safety strap devices. Generally, utilizing a walker to travel can be difficult, especially if the person is inexperienced at using the walker. The walker can be pushed too far out in front, causing improper balance and lack of stability. Losing balance can lead to slips, falls, and serious injuries.

Generally, walkers are commonly known in the art as devices that help persons with a limited ability to walk unassisted. These persons include the elderly, persons with degenerative conditions, other disabilities, and any other person in need of a balanced platform to attain mobility. Currently, there are many models and variations of walkers, but these walkers operate in generally the same way. First, a structure partially surrounds the user to provide stability in a plurality of directions. Next, the user engages the walker to travel in a given direction. In some models of walkers, the user picks the walker up and places the walker in a position forward of the user. Then, the user moves toward the walker aided by the stability of the walker. In other models of walkers, the walker includes wheels or skis between the structure of the walker and the ground. Thus, the user may simply push the walker to a position forward of the user. Then, as before, the user moves toward the walker aided by the stability of the walker.

While these walkers provide greater stability, they can also be difficult to utilize, as an inexperienced user could push or move the walker too far out in front of them causing balance problems which could result in injuries. Therefore, there is a need for a walker that includes a stability strap that ensures a user does not push the walker too far out in front of them during use.

Therefore, there exists a long-felt need in the art for a walker safety strap device that provides users with a strap designed to assist people in maintaining stability when using a walker. There is also a long-felt need in the art for a walker safety strap device that includes a breakaway buckle, so the strap is not used as a seat or support. Further, there is a long-felt need in the art for a walker safety strap device that features a C-shaped clip attached to the opposite side of the walker, behind the user, to secure the strap to the walker. Moreover, there is a long-felt need in the art for a device that prevents people from pushing the walker too far out in front of themselves which will reduce the chance of slips and falls. Further, there is a long-felt need in the art for a walker safety strap device that allows the breakaway buckle to break away if too much pressure is applied. Finally, there is a long-felt need in the art for a walker safety strap device that provides a precise marker of where a user should be standing when using a walker.

The subject matter disclosed and claimed herein, in one embodiment thereof, comprises a walker safety strap device. The device is a multipurpose strap that will assist a user in using a walker. The strap device functions as a bungee cord that will stretch from one side of the walker to the other, thereby providing the user with instruction for proper stance, balance, and distance from the walker. The walker safety strap device comprises a body component with a C-shaped hook at opposing ends, which secure to the walker and a breakaway buckle in the middle. Thus, the body component could be configured into two straps secured together by the breakaway buckle. Each strap component would have a first end and a second end, with a C-shaped hook secured to the first end and a breakaway buckle secured to the second end. Wherein, the breakaway buckles are secured together, and each C-shaped hook is secured to a side/end of a walker behind the user. Generally, the strap device is elastic and adjustable based on the size of the user and/or walker to ensure that the strap device keeps the user inside the one-foot circle created by the walker, during use. Thus, the breakaway buckle is used so that the strap device is not used as a seat or support, but as a safety measure if the strap is forgotten to be removed prior to the user sitting.

In this manner, the walker safety strap device of the present invention accomplishes all of the foregoing objectives and provides users with a device that provides stability for a walker during use. The device is an elastic strap that can be adjusted based on a user's size. The strap device is not meant to be used as a seat.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a walker safety strap device. The device is a multipurpose strap that will assist a user in using a walker. The strap device functions as a bungee cord that will stretch from one side of the walker to the other, thereby providing the user with instruction for proper stance, balance, and distance from the walker. The walker safety strap device comprises a body component with a C-shaped hook at opposing ends which secure to the walker and a breakaway buckle in the middle. The breakaway buckle is a safety measure to prevent users from injuring themselves by trying to sit on the strap device.

A walker with a walker safety strap device is disclosed. The walker in this particular embodiment comprises four leg portions disposed around the perimeter of the walker. The right two leg portions are rigidly connected to the left two leg portions via a front portion, leaving an open back portion which allows a user to enter and exit the walker. The right two leg portions comprise a front leg portion and a rear leg portion. Further, the left two leg portions comprise a front leg portion and a rear leg portion. The rigid connections between the portions define a user region, which is where the user stands when utilizing the walker. One skilled in the art will appreciate further embodiments where the connections between the portions are not rigid. Rather, in alternative embodiments the connections may be hinged or otherwise mobile to allow for articulation between the portions. Similarly, one skilled in the art will appreciate embodiments where the portions are a single continuous portion or additional portions may be utilized as is known in the art.

In one embodiment, the walker comprises leg portions that are telescoping in nature to allow users to adjust the height of the walker. Any suitable size and shape of walker can be utilized with the strap device, as is known in the art.

In one embodiment, the walker safety strap device is disposed between the right two leg portions and the left two leg portions at the rear of the walker. The walker safety strap device selectively connects the leg portions to define a user region and secures and encloses the user within the user region. Typically, the two opposing ends of the strap device are secured to the leg portions of the walker, however, in other embodiments, the strap device may have more than two ends disposed on one or more portions of the walker.

In one embodiment, the walker safety strap device has a width and a thickness, as described herein. The width of the strap device may be suitably narrow to reduce interference with the user and to not be mistaken for a seat or other support structure and sufficiently wide enough to secure the user and provide a precise marker of where the user should be standing when using the walker. As described herein, the thickness of the strap device may be sufficiently thin to allow easy entry into the walker.

In one embodiment, the walker safety strap device comprises a body component with a front side, a back side, opposing right and left ends, and opposing top and bottom ends.

In one embodiment, the walker safety strap device comprises a body component with a securing means secured at the opposing right and left ends of the body component. The securing means are configured to secure around the rear leg portions of the walker. The securing means can be any suitable securing means as is known in the art, such as a C-shaped hooks, Velcro, snaps, etc., depending on the needs and/or wants of a user. The securing means releasably secures around the rear leg portions of the walker allowing a user or another person (i.e., a nurse, a caregiver, etc.) to secure and unsecure the strap device easily. Thus, a user can unsecure one end of the strap device, then can step into the user region and secure the end of the strap device back to the rear leg portion of the walker. This secures the user within the walker and provides a precise marker of where the user should be standing when using the walker.

In another embodiment, the walker safety strap device comprises a breakaway buckle in the middle of the strap. The breakaway buckle can be any suitable breakaway securing means that allows the strap to separate when too much pressure is applied. Thus, the breakaway buckle prevents users from using the strap as a seat or support. The walker safety strap device is not meant to be utilized as a seat when using the walker. Further, the breakaway buckle is a safety measure that will release if too much pressure is applied. Accordingly, if the strap device is forgotten to be removed prior to the user exiting the walker and/or sitting down, pressure will be applied to the strap and the breakaway buckle will release preventing the user from tripping on the strap and injuring themselves.

In one embodiment, the body component could be configured into two straps secured together by the breakaway buckle. Each strap component would have opposing first and second ends with a C-shaped hook secured to the first end, and a breakaway buckle secured to the second end. Wherein, the breakaway buckles are secured together and each C-shaped hook is secured to a rear leg portion of the walker behind the user. Any suitable number of straps can be combined together and secured to the walker, based on the needs and/or wants of a user, as long as the breakaway buckle is positioned approximately in the middle of the strap as a safety precaution.

In one embodiment, the walker safety strap device is an elastic band or manufactured of an elastic or stretchy material, such as nylon, polyester, cotton, hemp, rubber, or elastomers, such as viscoelastic polymers or silicone gels or thermoplastic polyurethanes, thermoplastic poly olefins, polyamides, polyureas, polyesters, etc., and other polymer materials. Further, in one embodiment, the strap device can be manufactured of an outer layer of fabric which surrounds an inner elastic layer, such that the outer layer protects the inner elastic from abrasion or damage.

In another embodiment, the walker safety strap device is adjustable based on the size of the user and/or walker being utilized. Thus, the strap device would comprise an adjustable component that allows the strap to be tightened or loosened as needed. Further, the adjustability of the strap ensures that the strap device keeps the user inside the one-foot circle (i.e., user region) created by the walker, during use.

In one embodiment, the strap device and/or the walker may include lights such as LEDs or glow-in-the-dark materials or paints to illuminate the strap device and/or walker in dimly lit conditions.

In yet another embodiment, the walker safety strap device comprises a plurality of indicia.

In yet another embodiment, a method of providing stability to a user when utilizing a walker is disclosed. The method includes the steps of providing a walker safety strap device comprising a body component with a C-shaped hook at opposing ends which secures to the walker and a breakaway buckle in the middle. The method also comprises positioning the user within the walker in a conventional standing position. Further, the method comprises securing the C-shaped hooks to the walker, such that the strap device is positioned behind the user. Finally, the method comprises utilizing the walker normally and allowing the strap device to provide stability and safety to a user.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one embodiment of the walker safety strap device of the present invention in accordance with the disclosed architecture;

FIG. 2 illustrates a top perspective view of one embodiment of the walker safety strap device of the present invention showing the breakaway buckle in accordance with the disclosed architecture;

FIG. 3 illustrates a top perspective view of one embodiment of the walker safety strap device of the present invention showing the C-shaped hook in accordance with the disclosed architecture;

FIG. 4 illustrates a top perspective view of one embodiment of the walker safety strap device of the present invention showing how the buckle breaks away if too much pressure is applied in accordance with the disclosed architecture;

FIG. 5 illustrates a perspective view of one embodiment of the walker safety strap device of the present invention in use in accordance with the disclosed architecture; and

FIG. 6 illustrates a flowchart showing the method of providing stability to a user when utilizing a walker in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a walker safety strap device that provides users with a strap designed to assist people in maintaining stability when using a walker. There is also a long-felt need in the art for a walker safety strap device that includes a breakaway buckle so the strap is not used as a seat or support. Further, there is a long-felt need in the art for a walker safety strap device that features a C-shaped clip attached to the opposite side of the walker, behind the user, to secure the strap to the walker. Moreover, there is a long-felt need in the art for a device that prevents people from pushing the walker too far out in front of themselves which will reduce the chance of slips and falls. Further, there is a long-felt need in the art for a walker safety strap device that allows the breakaway buckle to break away if too much pressure is applied. Finally, there is a long-felt need in the art for a walker safety strap device that provides a precise marker of where a user should be standing when using a walker.

The present invention, in one exemplary embodiment, is a novel walker safety strap device. The device is a multipurpose strap that will assist a user in using a walker. The strap device functions as a bungee cord that will stretch from one side of the walker to the other, thereby providing the user with instruction for proper stance, balance, and distance from the walker. The walker safety strap device comprises a body component with a C-shaped hook at opposing ends which secure to the walker and a breakaway buckle in the middle. Generally, the strap device is elastic and adjustable based on the size of the user and/or walker to ensure that the strap device keeps the user inside the one-foot circle created by the walker during use. The present invention also includes a novel method of providing stability to a user when utilizing a walker. The method includes the steps of providing a walker safety strap device comprising a body component with a C-shaped hook at opposing ends which secures to the walker and a breakaway buckle in the middle. The method also comprises positioning the user within the walker in a conventional standing position. Further, the method comprises securing the C-shaped hooks to the walker, such that the strap device is positioned behind the user. Finally, the method comprises utilizing the walker normally and allowing the strap device to provide stability and safety to a user.

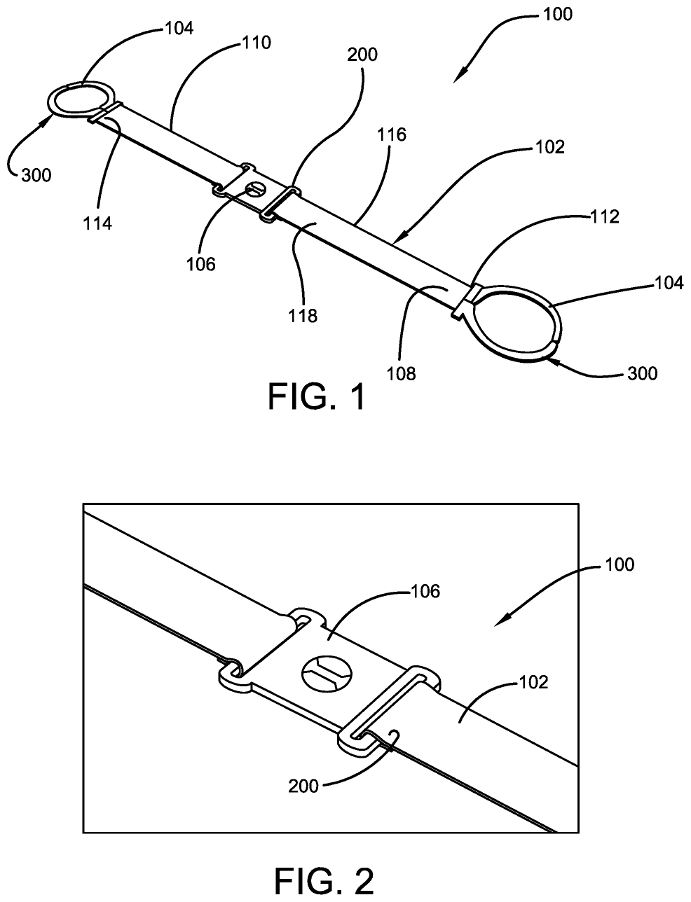

Referring initially to the drawings, FIG. 1 illustrates a perspective view of one embodiment of the walker safety strap device 100 of the present invention. In the present embodiment, the walker safety strap device 100 is an improved safety strap device 100 that assists a user 500 in using a walker 502. Further, the device 100 is a multipurpose strap that provides the user 500 with a precise marker of where he or she should be standing when using a walker 502. Specifically, the walker safety strap device 100 comprises a body component 102 with a C-shaped hook 104 at opposing ends which secure to the walker 502 and a breakaway buckle 106 in the middle. The strap device 100 functions as a bungee cord that will stretch from one side of the walker 502 to the other, thereby providing the user 500 with instruction for proper stance, balance, and distance from the walker 502. The breakaway buckle 106 is a safety measure to prevent users 500 from injuring themselves by trying to sit on the strap device 100.

A walker 502 with a walker safety strap device 100 is disclosed at FIG. 5. The walker 502 in this particular embodiment comprises four leg portions 504, 506, 508, 510 disposed around the perimeter of the walker 502. The right two leg portions 504, 506 are rigidly connected to the left two leg portions 508, 510 via a front portion 512 of the walker 502 leaving an open back portion 514 which allows a user 500 to enter and exit the walker 502. The right two leg portions 504, 506 comprise a front leg portion 504 and a rear leg portion 506. Further, the left two leg portions 508, 510 comprise a front leg portion 508 and a rear leg portion 510. The rigid connections between the portions define a user region 516, which is where the user 500 stands when utilizing the walker 502. One skilled in the art will appreciate further embodiments where the connections between the portions are not rigid. Rather, in alternative embodiments, the connections may be hinged or otherwise mobile to allow for articulation between the portions. Similarly, one skilled in the art will appreciate embodiments where the portions are a single continuous portion or additional portions may be utilized as is known in the art, as well.

Additionally, in one embodiment, the walker 502 comprises leg portions 504, 506, 508, 510 that are telescoping in nature to allow users 500 to adjust the height of the walker 502. Any suitable size and shape of walker 502 can be utilized with the strap device 100, as is known in the art.

Generally, the walker safety strap device 100 is disposed between the right two leg portions 504, 506 and the left two leg portions 508, 510 at the rear of the walker 502. The walker safety strap device 100 selectively connects the leg portions (specifically, right rear leg portion 506 and left rear leg portion 510) to define a user region 516 and secures and encloses the user 500 within the user region 516. Typically, the two opposing ends of the strap device 100 are secured to the leg portions 506, 510 of the walker 502, however, in other embodiments, the strap device 100 may have more than two ends disposed on one or more portions of the walker 502.

Furthermore, the walker safety strap device 100 has a width and a thickness as described herein. The width of the strap device 100 may be suitably narrow to reduce interference with the user 500 and to not be mistaken for a seat or other support structure but is sufficiently wide enough to secure the user 500 and provide a precise marker of where the user 500 should be standing when using the walker 502. As described herein, the thickness of the strap device 100 may also be sufficiently thin to allow easy entry into the walker 502.

Typically, the walker safety strap device 100 comprises a body component 102 with a front side 108, a back side 110, opposing right 112 and left 114 ends, and opposing top 116 and bottom 118 ends. However, the body component 102 can be any suitable size and shape as is known in the art, as long as the body component 102 acts to stretch from one side of the walker 502 to the second side.

As shown in FIG. 2, the walker safety strap device 100 comprises a breakaway buckle 106 in the middle 200 of the strap 100. The breakaway buckle 106 can be any suitable breakaway securing means that allows the strap 100 to separate when too much pressure is applied. Thus, the breakaway buckle 106 prevents users from using the strap 100 as a seat or support. The walker safety strap device 100 is not meant to be utilized as a seat when using the walker 502. Further, the breakaway buckle 106 is a safety measure that will release if too much pressure is applied. Accordingly, if the strap device 100 is forgotten to be removed prior to the user 500 exiting the walker 502 and/or sitting down, pressure will be applied to the strap 100 and the breakaway buckle 106 will release preventing the user 500 from tripping on the strap 100 and injuring themselves.

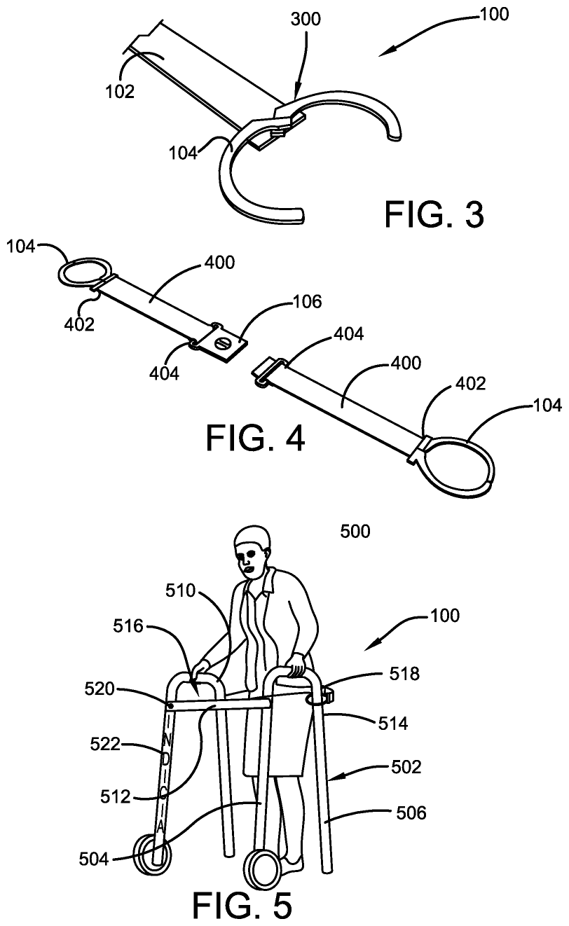

As shown in FIG. 3, the walker safety strap device 100 comprises a body component 102 with a securing means 300 secured at the opposing right 112 and left 114 ends of the body component 102. The securing means 300 are configured to secure around the rear leg portions 506, 510 of the walker 502. The securing means 300 can be any suitable securing means as is known in the art, such as a C-shaped hooks 104, Velcro, snaps, etc., depending on the needs and/or wants of a user 500. The securing means 300 releasably secures around the rear leg portions 506, 510 of the walker 502 allowing a user 500 or another person (i.e., a nurse, a caregiver, etc.) to secure and unsecure the strap device 100 easily. Thus, a user 500 can unsecure one end 112 or 114 of the strap device 100 and can then step into the user region 516 and secure the end 112 or 114 of the strap device 100 back to the rear leg portion 506 or 510 of the walker 502. This secures the user 500 within the walker 502 and provides a precise marker of where the user 500 should be standing when using the walker 502.

As shown in FIG. 4, the body component 102 could be configured into two straps 400 secured together by the breakaway buckle 106. Each strap component 400 would have opposing first 402 and second 404 ends with a C-shaped hook 104 secured to the first end 402 and a breakaway buckle 106 secured to the second end 404. The breakaway buckles 106 are secured together and each C-shaped hook 104 is secured to a rear leg portion 506, 510 of the walker 502 behind the user 500. Any suitable number of strap components 400 can be combined together and secured to the walker 502, based on the needs and/or wants of a user 500, as long as the breakaway buckle 106 is positioned approximately in the middle 200 of the strap components 400 (when secured together) as a safety precaution.

As shown in FIG. 5, the walker safety strap device 100 is an elastic band or manufactured of an elastic or stretchy material, such as nylon, polyester, cotton, hemp, rubber, or elastomers, such as viscoelastic polymers or silicone gels or thermoplastic polyurethanes, thermoplastic poly olefins, polyamides, polyureas, polyesters, etc., and other polymer materials. Further, in one embodiment, the strap device 100 can be manufactured of an outer layer of fabric which surrounds an inner elastic layer, such that the outer layer protects the inner elastic from abrasion or damage.

In another embodiment, the walker safety strap device 100 is adjustable based on the size of the user 500 and/or walker 502 being utilized. Thus, the strap device 100 would comprise an adjustable component 518 that allows the strap 100 to be tightened or loosened as needed. Further, the adjustability of the strap 100 ensures that the strap device 100 keeps the user 500 inside the one-foot circle (i.e., user region 516) created by the walker 502, during use.

In one embodiment, the strap device 100 and/or the walker 502 may include lights 520 such as LEDs or glow-in-the-dark materials or paints to illuminate the strap device 100 and/or walker 502 in dimly lit conditions.

Furthermore, the walker safety strap device 100 comprises a plurality of indicia 522. The body component 102 of the device 100 may include advertising, trademark, or other letters, designs, or characters, printed, painted, stamped, or integrated into the body component 102, or any other indicia 522 as is known in the art. Specifically, any suitable indicia 522 as is known in the art can be included, such as, but not limited to, patterns, logos, emblems, images, symbols, designs, letters, words, characters, animals, advertisements, brands, etc., that may or may not be walker, safety, or brand related.

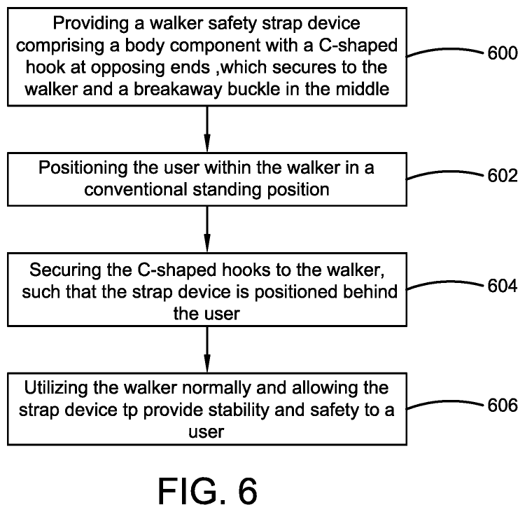

FIG. 6 illustrates a flowchart of the method of providing stability to a user when utilizing a walker. The method includes the steps of at 600, providing a walker safety strap device comprising a body component with a C-shaped hook at opposing ends which secures to the walker and a breakaway buckle in the middle. The method also comprises at 602, positioning the user within the walker in a conventional standing position. Further, the method comprises at 604, securing the C-shaped hooks to the walker, such that the strap device is positioned behind the user. Finally, the method comprises at 606, utilizing the walker normally and allowing the strap device to provide stability and safety to a user.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “walker safety strap device”, “strap device”, and “device” are interchangeable and refer to the walker safety strap device 100 of the present invention.

Notwithstanding the foregoing, the walker safety strap device 100 of the present invention can be of any suitable size and configuration as is known in the art without affecting the overall concept of the invention, provided that it accomplishes the above-stated objectives. One of ordinary skill in the art will appreciate that the walker safety strap device 100 as shown in FIGS. 1-6 are for illustrative purposes only, and that many other sizes and shapes of the walker safety strap device 100 are well within the scope of the present disclosure. Although the dimensions of the walker safety strap device 100 are important design parameters for user convenience, the walker safety strap device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A walker safety strap device that assists a user in using a walker, the walker safety strap device comprising:
a body component comprising opposing right and left ends;
a securing means secured to both the opposing right and left ends; and
a breakaway buckle positioned in middle of the body component;
wherein the body component is secured between a top of a pair of rear legs of the walker to maintain the user within the walker during use;
wherein if pressure is applied to the body component, the breakaway buckle separates to prevent injury; and
further wherein the walker safety strap device functions as a precise marker of where the user should be standing when using the walker.

2. The walker safety strap device of claim 1, wherein the walker comprises a right two leg portions rigidly connected to a left two leg portions via a front portion, leaving an open back portion which forms a user region for the user to stand during use.

3. The walker safety strap device of claim 2, wherein the right two leg portions comprise a front leg portion and a rear leg portion and the left two leg portions comprise a front leg portion and a rear leg portion.

4. The walker safety strap device of claim 3, wherein the body component is disposed between the right rear leg portion and the left rear leg portion to secure and enclose the user within the user region.

5. The walker safety strap device of claim 4, wherein the body component comprises a front side, a back side, opposing right and left ends, and opposing top and bottom ends.

6. The walker safety strap device of claim 5, wherein the breakaway buckle is positioned in the middle of the body component and acts to separate the body component when too much pressure is applied, preventing users from using the body component as a seat or support.

7. The walker safety strap device of claim 6, wherein the securing means is a C-shaped hook, which releasably secures around the right and left rear leg portions of the walker.

8. The walker safety strap device of claim 7, wherein the body component could be configured into two straps secured together by the breakaway buckle.

9. The walker safety strap device of claim 8, wherein each of the two straps would have opposing first and second ends, with a C-shaped hook secured to the first end and a breakaway buckle secured to the second end.

10. The walker safety strap device of claim 9, wherein the body component is an elastic band.

11. The walker safety strap device of claim 10, wherein the body component is adjustable based on size of the user and the walker being utilized.

12. The walker safety strap device of claim 11, wherein the body component comprises a plurality of lights for dimly lit conditions.

13. A walker safety strap device that assists a user in using a walker, the walker safety strap comprising:
a body component comprising a front side, a back side, opposing right and left ends, and opposing top and bottom ends;
a C-shaped hook secured to both the opposing right and left ends; and
a breakaway buckle positioned in middle of the body component;
wherein the body component is secured between a top of a pair of rear legs of the walker to maintain the user within the walker during use;
wherein the breakaway buckle is positioned in the middle of the body component and acts to separate the body component when too much pressure is applied, thereby preventing the user from using the body component as a seat or support and preventing injuries;
wherein the body component is an adjustable elastic band; and
further wherein the walker safety strap device functions as a precise marker of where the user should be standing when using the walker.

14. The walker safety strap device of claim 13 further comprising a plurality of indicia.

15. The walker safety strap device of claim 13, wherein the walker comprises a right two leg portions rigidly connected to a left two leg portions via a front portion, leaving an open back portion which forms a user region for the user to stand during use.

16. The walker safety strap device of claim 15, wherein the right two leg portions comprise a front leg portion and a rear leg portion and the left two leg portions comprise a front leg portion and a rear leg portion.

17. The walker safety strap device of claim 16, wherein the body component is disposed between the right rear leg portion and the left rear leg portion to secure and enclose the user within the user region.

18. The walker safety strap device of claim 13, wherein the body component could be configured into two straps secured together by the breakaway buckle.

19. The walker safety strap device of claim 18, wherein each of the two straps would have opposing first and second ends, with a C-shaped hook secured to the first end and a breakaway buckle secured to the second end.

20. A method of providing stability to a user when utilizing a walker, the method comprising the following steps:
providing a walker safety strap device comprising a body component with a C-shaped hook at opposing ends, which secures to the walker and a breakaway buckle in the middle;
positioning the user within the walker in a conventional standing position;
securing the C-shaped hooks to the walker, such that the strap device is positioned behind the user; and
utilizing the walker normally and allowing the strap device to provide stability and safety to a user.
